(19) United States
(12) Patent Application Publication
(10) Pub. No.: US 2022/0237658 A1
(43) Pub. Date: Jul. 28, 2022

(54) SYSTEMS AND METHODS TO FACILITATE TARGETED ADVERTISING ON AUTOMOBILES

(71) Applicant: BlueOwl, LLC, San Francisco, CA (US)

(72) Inventors: Tina Fang, San Jose, CA (US); Kenneth Jason Sanchez, San Francisco, CA (US); Theobolt N. Leung, San Francisco, CA (US)

(21) Appl. No.: 16/795,152

(22) Filed: Feb. 19, 2020

(51) Int. Cl. G06Q 30/02; H04W 4/40; G06K 9/00

(52) U.S. Cl. CPC G06Q 30/0265; G06Q 30/0252; G06K 9/00664; G06Q 30/0275; G06Q 30/0204; H04W 4/40

(57) ABSTRACT

An electronic device for displaying targeted messages on a surface of a vehicle is presented. The device includes a transceiver, one or more memories and processors, and an electronic display disposed on the surface. The electronic display displays a targeted message for a set of individuals associated with an environment of the vehicle. The one or more processors may detect environmental data associated with the environment of the vehicle, and generate demographic data from the environmental data. The generated demographic data may be indicative of at least one individual of the set of individuals. Further, the one or more processors may transmit the demographic data to an external processing server, which determines the targeted message from the demographic data. Finally, the one or more processors may receive the targeted message from the external processing server, and display the targeted message on the electronic display.

### FIELD OF THE DISCLOSURE

The present disclosure generally relates to determining targeted advertisements for display on a vehicle exterior and, more particularly, to a system and method for analyzing a vehicle environment to determine a targeted advertisement based at least in part on demographic data corresponding to a set of individuals associated with the vehicle environment.

### BACKGROUND

Digital billboards were first placed along roadways over a decade ago, and rose to prominence soon thereafter. These billboards provide higher visibility than traditional billboards and can be configured to cycle through multiple displays as opposed to the singular static display of a traditional billboard.

However, digital billboards suffer from several drawbacks. First, conventional digital billboards lack readability, similar to a traditional billboard, because they are displaced away from the roadway, and consequently, the motorists attempting to view them. Second, conventional digital billboards also suffer from an increased distraction potential for motorists due to the higher visibility and changing display. Third, conventional digital billboards suffer from a lack of relevant message displays to accommodate shifting interests/priorities of those viewing the message displays.

### SUMMARY

This Summary is provided to introduce a selection of concepts in a simplified form that are further described below in the Detailed Description. This Summary is not intended to be used to limit the scope of the claimed subject matter.

In one embodiment, a system for displaying targeted messages on a surface of a vehicle may be provided. The device may comprise a transceiver; one or more memories; an electronic display disposed on the surface; and one or more processors interfacing with the transceiver, the one or more memories, and the electronic display. The one or more processors may be configured to: detect environmental data associated with an environment of the vehicle, the environmental data indicating a set of individuals associated with the environment of the vehicle, generate demographic data from the environmental data, wherein the demographic data are indicative of at least one individual of the set of individuals, transmit, to an external processing server via the transceiver, the demographic data, wherein the external processing server determines a targeted message from the demographic data, receive, from the external processing server via the transceiver, the targeted message, and cause the electronic display to display the targeted message for viewing by the set of individuals associated with the environment of the vehicle.

In another embodiment, a computer-implemented method for displaying targeted messages on a surface of a vehicle may be provided. The method may comprise detecting, by an electronic device, environmental data associated with an environment of the vehicle, the environmental data indicating a set of individuals associated with the environment of the vehicle; generating, by the electronic device, demographic data from the environmental data, wherein the demographic data are indicative of at least one individual of the set of individuals; determining, by an external processing server, a targeted message from the demographic data; transmitting, by the external processing server, the targeted message to the electronic device; and displaying, by the electronic device, the targeted message for viewing by the set of individuals associated with the environment of the vehicle on an electronic display disposed on the surface.

In yet another embodiment, a computer readable storage medium comprising non-transitory computer readable instructions stored thereon for displaying targeted messages on a surface of a vehicle may be provided. The instructions when executed on one or more processors may cause the one or more processors to detect environmental data associated with an environment of the vehicle, the environmental data indicating a set of individuals associated with the environment of the vehicle; generate demographic data from the environmental data, wherein the demographic data are indicative of at least one individual of the set of individuals; determine a targeted message from the demographic data; and display the targeted message for viewing by the set of individuals associated with the environment of the vehicle on an electronic display disposed on the surface.

### BRIEF DESCRIPTION OF THE DRAWINGS

The figures described below depict various aspects of the systems and methods disclosed herein. It should be understood that each figure depicts an embodiment of a particular aspect of the disclosed systems and methods, and that each of the figures is intended to accord with one or more embodiments thereof. Further, wherever possible, the following description refers to the reference numerals included in the following figures, in which features depicted in multiple figures are designated with consistent reference numerals.

FIG. 1 illustrates an example system for facilitating targeted advertising on automobiles;

FIG. 2 illustrates another example system for facilitating targeted advertising on automobiles;

FIG. 3 depicts an operational embodiment of, for example, the system of FIG. 2;

FIG. 4 is a flowchart depicting an example method corresponding to various embodiments of the present disclosure.

The figures depict various aspects of the present disclosure for purposes of illustration only. One skilled in the art will readily recognize from the following discussion that alternative embodiments of the structures and methods illustrated herein may be employed without departing from the principles of the invention described herein.

### DETAILED DESCRIPTION

### I. Example System and Related Functionality for Facilitating Targeted Advertising on Automobiles According to Certain Embodiments

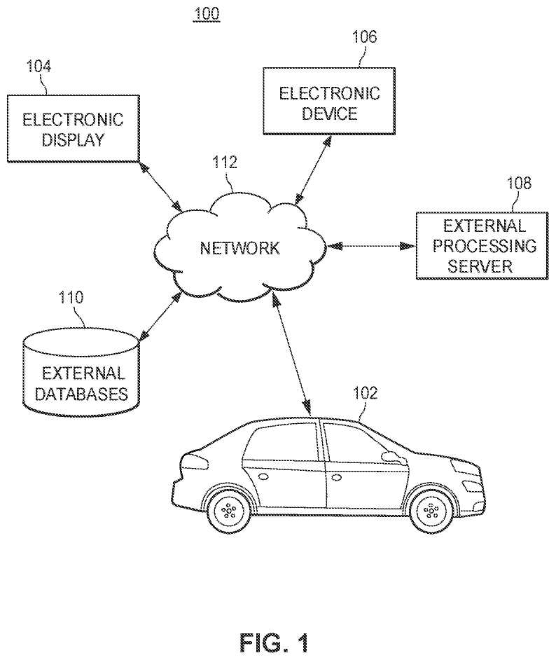

FIG. 1 illustrates an example system 100 for facilitating targeted advertising on automobiles. The example system 100 may include a vehicle 102, an electronic display 104, an electronic device 106, an external processing server 108 (e.g., referenced herein as an “auction host server”), external databases 110, and a network 112. While illustrated in FIG. 1 as a single external database, in some embodiments the external databases 110 includes two or more external databases. The network 112 may be a computer network of an insurance provider (e.g., provided or used by the insurance provider or communications over which the insurance provider otherwise controls or facilitates).

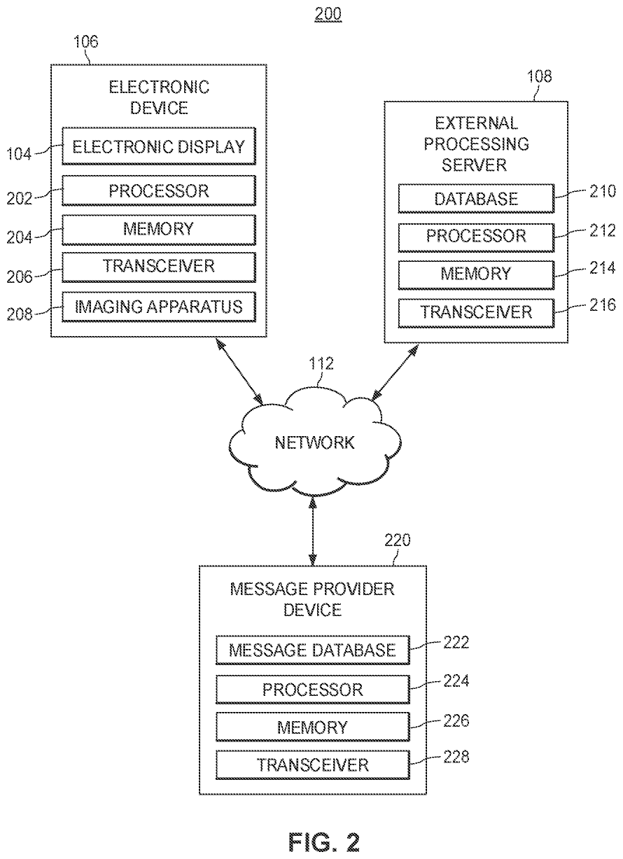

FIG. 2 illustrates another example system for facilitating targeted advertising on automobiles. In reference to the example system 200 of FIG. 2, the electronic device 106 may include the electronic display 104, a processor 202, a memory 204, a transceiver 206, and an imaging apparatus 208. While referred to herein as a “processor” and a “memory,” in some embodiments the processor 202 includes two or more processors and the memory 204 includes two or more memories. The processor 202 may be configured to analyze both still image data and video data (e.g., video data received by the transceiver 206) and analyze aspects of the still image data and/or video data. The memory 204 may store computer-executable instructions, which may be executed by the processor 202.

It should be understood that the electronic display 104 may be either an external, standalone device or an internal component of the electronic device 106. In other words, in embodiments, the electronic display 104 may be a standalone entity affixed to a surface of a vehicle (e.g., vehicle 102). In that case, the electronic display 104 may have a processor, memory, imaging assembly, transceiver, etc. and be configured to receive a targeted message from the electronic device 106, external processing server 108, or any other suitable transmitter (e.g., external databases 110).

The imaging apparatus 208 may include, for example, an image sensor (e.g., a camera, a video camera), and/or a proximity sensor. As such, the imaging apparatus 208 may be configured to capture still images, video footage, proximity information (e.g., indicative of distances to/from imaging apparatus). However, it should be understood that the imaging apparatus 208 is not limited to the sensors disclosed herein. Additionally, the electronic device 106 may be configured to receive communications from the external processing server 108 and/or other suitable transmitters (e.g., external databases 110) in response to transmitting captured data and/or before, during, or after displaying a targeted message.

The external processing server 108 may include a database 210, a processor 212, a memory 214, and a transceiver 216. While referred to herein as a “processor” and a “memory,” in some embodiments the processor 212 includes two or more processors and the memory 214 includes two or more memories. The processor 212 may be configured to process both still image data and video data (e.g., video data received from a prospective client) and analyze aspects of the still image data and/or video data. The memory 214 may store computer-executable instructions, which may be executed by the processor 212. The database 210 may include message display profiles. The message display profiles may correspond to a set of information associating a vehicle with certain message display characteristics and/or priorities. For example, a message display profile may indicate that a particular vehicle (e.g., vehicle 102) may consistently drive in low population density areas, and may further drive in those areas late at night. As further discussed herein, based on the message display profile, the external processing server 108 may determine targeted messages for display on the electronic display 104 and/or auction rates corresponding to the vehicle 102. The message display profiles may also correspond with insured user profiles/accounts, insurance policies, or other user profiles, accounts, policies, etc.

Further, the message display profile may include relevant data associated with a user indicated in the message display profile. For example, if a message display profile is an insurance policy listing a first user as the insured, the insurance policy may list the first user's name, age, gender, etc. Moreover, and as discussed further herein, the relevant data may include multiple profile features associated with each message display profile. These profile features may, for example and as discussed further herein, facilitate targeted message display on a vehicle 102 by allowing the external processing server 108 to develop a broader knowledge base with which to determine the targeted messages for display.

The system 200 further includes a message provider device 220. The message provider device 220 includes a message database 222, a processor 224, a memory 226, and a transceiver 228. While referred to herein as a “processor” and a “memory,” in some embodiments the processor 224 includes two or more processors and the memory 226 includes two or more memories. The message database 222 may include a set of messages for display, for example, on the electronic display 104 disposed on a surface of the vehicle 102.

The message provider device 220 may be connected to each of the electronic device 106 and the external processing server 108 via the network 112, such that all devices (e.g., 106, 108, and 220) may communicate to each other via their respective transceivers (e.g., 206, 216, and 228). For example, the external processing server 108 may receive updated message display profile information from the electronic device 106. The external processing server 108 may store this received information in its database 210 and/or its memory 214. Thus, and as discussed further herein, the external processing server 108 may be configured to process, analyze, or otherwise interpret data captured by and/or received from the electronic device 106. Moreover, the message provider device 220 may transmit targeted message data to the electronic device 106 and/or external processing server 108 through the network 112. The device 106 and/or server 108 may receive the targeted message and store it in the memory 204 and/or 214 respectively, and/or the server 108 may further transmit the targeted message to the electronic device 106 and/or electronic display 104 for display. It will be appreciated that the external processing server 108 and/or message provider device 220 may be a server and/or device provided by or used by an insurance provider, or use of which the insurance provider otherwise controls or facilitates.

In embodiments, the network 112 may be or may include a network such as the Internet and/or any other type of suitable network (e.g., a local area network (LAN), a metropolitan area network (MAN), a wide area network (WAN), a mobile network, a wired or wireless network, a private network, a virtual private network, etc.). The network 112 may also or alternatively be or include one or more cellular networks such as code division multiple access (CDMA) network, GSM (Global System for Mobile Communications) network, WiMAX (Worldwide Interoperability for Microwave Access) network, Long Term Evolution (LTE) network, etc.

As further described below, the example systems (e.g., 100, 200) facilitate targeted message display on automobiles, and allow, among other advantages, readable messages that have a limited distraction potential for motorists and are relevant to those viewing the messages. The messages displayed on the systems described herein are more readable than those of conventional digital displays because the messages are displayed on vehicles that are closer to both pedestrians and proximate vehicles than the conventional display devices (e.g., billboards). Placing the targeted messages on proximate vehicles reduces distraction potential for other motorists and pedestrians alike because the messages keep their focus nearer to their local surroundings (e.g., active roadways, sidewalks, crosswalks, etc.) instead of the elevated positions of conventional display devices that remove their focus from such surroundings. The messages are also more relevant than the static, general messages on conventional display devices because they are dynamically updated and targeted for the proximate viewing audience (e.g., proximate motorists and pedestrians).

### II. Example Operational Embodiments of the System

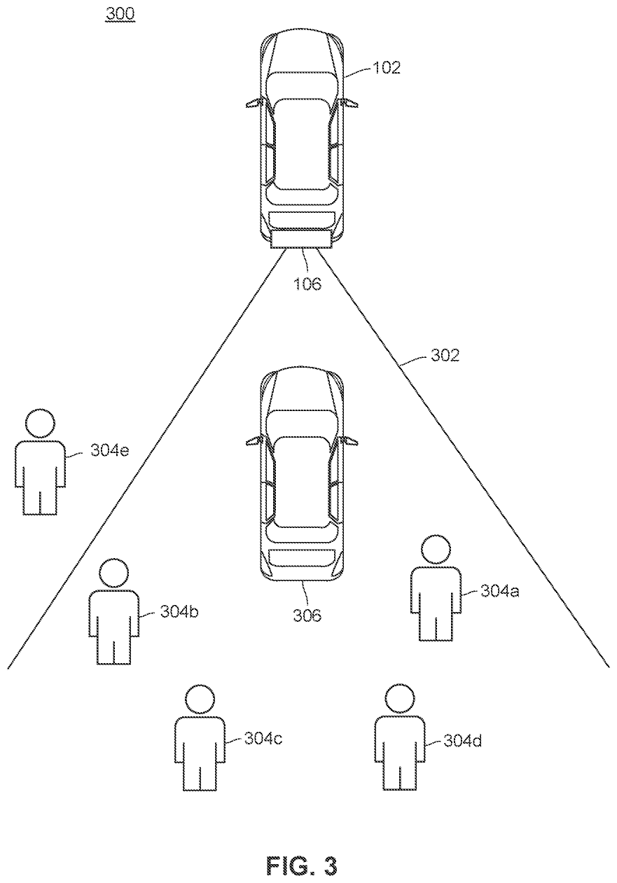

FIG. 3 depicts an operational embodiment 300 of, for example, the system 200. The operational embodiment 300 includes the vehicle 102 and the electronic device 106. The electronic device 106 includes a field of view (FOV) 302 indicating an area where the device's 106 sensors (e.g., imaging apparatus 208) are capable of capturing data (e.g., environmental data). In embodiments, the vehicle 102 may have a sensor or sensors surrounding its exterior and thus may have an effective FOV 302 corresponding to the entire surrounding environment of the vehicle or any portion of the surrounding environment therein. Moreover, and as discussed further herein, the FOV 302 may have a range of any suitable degree to capture the needed environmental data. For example, the device's 106 sensors may be disposed at a plurality of locations around the vehicle 102 such that the entire environment (e.g., 360° view surrounding the vehicle 102) is captured to yield environmental data.

The operational embodiment 300 further includes a set of individuals 304a-304d inside the FOV 302, an individual 304e outside the FOV 302, and a vehicle 306 inside the FOV 302. Thus, as depicted, the electronic device 106 may capture environmental data corresponding to the set of individuals 304a-304d and the vehicle 306. For example, the vehicle 102 may be traveling on a residential street, and the vehicle 306 may be following along the street with the set of individuals 304a-304d walking on nearby sidewalks/crosswalks. Thus, when the electronic device 106 captures environmental data, the set of individuals 304a-304d and the vehicle 306 occupants may be included in the environmental data because they are inside the FOV 302. In this example, the individual 304e may be far enough away from the vehicle 102 to be outside the FOV 302. However, as the vehicle 102 drives along the street, the individual 304e may eventually come into the FOV 302 and be included in the analysis for determining a targeted message, in accordance with various embodiments and as discussed further herein.

After the electronic device 106 captures the environmental data, the device 106 may determine demographic data from the environmental data. The demographic data are indicative of at least one individual of the set of individuals (e.g., 304a-304d, 306), such that analyzing the data will facilitate determining a targeted message. Thus, after analyzing the demographic data, the external processing server 108 may determine a targeted message, and transmit the targeted message to the electronic device 106 for display. Accordingly, the set of individuals (e.g., 304a-304d, 306) may view the targeted message via the electronic device 106, and more particularly, via the electronic display 104. While being outside the FOV 302, the individual 304e may also view the targeted message if, as depicted, the individual 304e is in a position where viewing the message may be possible (e.g., in this embodiment, behind the vehicle 102).

### III. Example of a Method for Facilitating Targeted Advertising on Automobiles

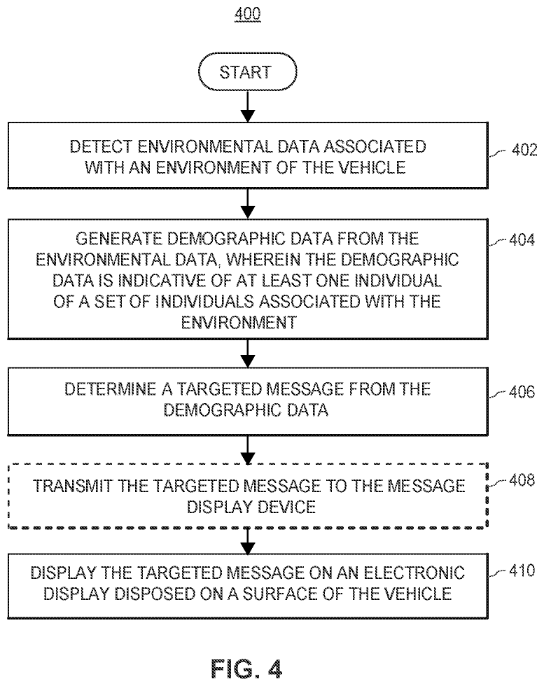

FIG. 4 is a flowchart depicting an example method 400 corresponding to various embodiments of the present disclosure. The method 400 begins at block 402 where, for example, a computer processor (e.g., electronic device 106) detects environmental data associated with an environment of a vehicle (e.g., vehicle 102). The environment may be area located proximate to and/or extending away from the vehicle 102. For example, the environment may be or include a street, a highway, an interstate, sidewalks, crosswalks, front lawns, parking lots, etc. The environmental data may indicate a set of individuals (e.g., 304a-304d, 306) associated with the environment of the vehicle 102. Block 402 may be performed by, for example, the electronic device 106.

In embodiments, the computer processor (e.g., electronic device 106) may receive the environmental data from one or more of (i) vehicle-to-vehicle (V2V) communication protocols, (ii) vehicle-to-infrastructure (V2I) communication protocols, or (iii) one or more mobile devices. For example, the computer processor may communicate, via the transceiver 206, with other vehicles (e.g., vehicle 306) to determine environmental data concerning the vehicle 306 and its occupants. The computer processor may receive environmental data such as the year, make, model, VIN of the vehicle 306, and/or any associated user information linked with the vehicle data. As one example, the environmental data received from the vehicle 306 may be associated with an insurance policy covering the vehicle 306. The vehicle 102 may access this insurance policy and extract other information from the policy that may be relevant. The policy may indicate, inter alia, covered drivers for the automobile and basic identifying information for those drivers (e.g., name, age, sex, driving experience, license number, license issuing state, etc.). As discussed further herein, the external processing server 108 may receive and use such information when determining a targeted message for display on the computer processor, and more specifically, the electronic display 104.

In embodiments, detecting the environmental data may further include capturing the environmental data via the imaging apparatus 208. The imaging apparatus 208 may include an image sensor, and the image sensor may be configured to capture a set of digital images. The set of digital images may be included in or otherwise comprise the environmental data. To illustrate, the imaging apparatus 208 may capture a set of digital images featuring a set of individuals (e.g., 304a-304d, 306). The imaging apparatus 208 may capture the set of digital images in response to detecting that at least one entity (e.g., one individual of the set of individuals 304a-304d, the vehicle 306 occupant(s)) is within the FOV 302, and/or in response to the proximity sensor or any other sensor included in the imaging apparatus 208 detecting the presence of at least one entity within the FOV 302.

The imaging apparatus 208 may also include a proximity sensor, and the proximity sensor may be configured to capture a set of proximity data. The proximity data may be indicative of a set of distances from the vehicle 102 to the set of individuals (e.g., 304a-304d, 306). To illustrate, the proximity sensor may capture a set of proximity data indicative of a set of distances from the vehicle 102 for each of the set of individuals (e.g., 304a-304d, 306). The proximity sensor may further determine that individual 304a is 10 feet from the vehicle 102, individual 304b is 12 feet from the vehicle 102, etc. Additionally, the proximity sensor may determine that individual 304a is 10 feet from the right rear panel of the vehicle 102, individual 304b is 12 feet from the left rear panel of the vehicle 102, etc.

In embodiments, the electronic device 106 may transmit, via the transceiver 206, the set of distances and the set of digital images to the external processing server 108. As discussed further herein, the external processing server 108 may then determine the targeted message by correlating the set of distances with the set of digital images. For example, the external processing server 108 may prioritize messages that are more relevant to the individuals closer to the vehicle 102, and thus, the electronic device 106.

As an illustration, the electronic device 106 may transmit the set of distances and set of digital images indicative of a set of individuals (e.g., 304a-304d, 306) to the external processing server 108. The external processing server 108 may determine that because individuals 304c and 304d are farther from the vehicle 102 than individuals 304a, 304b, and the occupants of vehicle 306, individuals 304c and 304d are less likely to view the displayed message. In response, the server 108 may determine a targeted message that is primarily relevant to individuals 304a, 304b, and the occupants of vehicle 306, and that is less relevant to individuals 304c and 304d.

The method 400 continues at block 404 by generating demographic data from the environmental data. The demographic data are indicative of at least one individual of the set of individuals (e.g., the set of individuals 304a-304d and the vehicle 306 occupants) associated with the environment. The environmental data may contain images and/or other representations of a set of individuals from which the computer processor (e.g., electronic device 106) may generate the demographic data. Thus, the computer processor may use any of a number of extraction techniques to generate the demographic data from the environmental data. For example, the computer processor may include (i) facial recognition, (ii) object recognition (OR), (iii) object character recognition (OCR), and/or any other suitable extraction technique. Block 404 may be performed by, for example, the electronic device 106.

Moreover, the computer processor may incorporate other relevant features into the demographic data. For example, the computer processor may include (i) a location of the vehicle, (ii) a time when the image sensor captured the set of digital images, (iii) an age of a respective individual of the set of individuals, (iv) a gender of the respective individual, (v) a height of the respective individual, or (vi) a weight of the respective individual.

As an illustration, the electronic device 106 may detect environmental data indicative of a set of individuals (e.g., 304a-304d, 306). The environmental data may include a location of the vehicle 102 (e.g., an address associated with an elementary school) and a time when the vehicle 102 is at the location (e.g., 3:00 pm on a Wednesday during the school year). The electronic device 106 may also generate data indicating that several individuals (e.g., 304a and 304b) are relatively shorter (e.g., under 5′ tall) than several other individuals (e.g., 304c and 304d, who are each over 5′ tall). Thus, using all of this demographic data, and as discussed at block 406, the external processing server 108 may determine that the vehicle is in an elementary school carpool line, and that several of the individuals located in the electronic device's 106 FOV 302 are children.

The method 400 continues at block 406 by determining a targeted message from the demographic data. As discussed further herein, the computer processor may determine the targeted message based on a stored selection of messages (e.g., stored in database 210 and/or message database 222), the computer processor may receive a targeted message from an external source (e.g., message provider device 220), or the computer processor may retrieve a relevant message from an external source (e.g., external databases 110). For example, the computer processor may analyze the demographic data to determine a set of tags representative of the set of individuals (e.g., 304a-304d, 306) indicated in the demographic data. This set of tags may include data corresponding to any of the information indicated herein, including vehicle location, time of day, weather, individual ages, individual genders, individual heights, individual weights, individual ethnic indicators, and/or any other suitable demographic indication. Using this set of tags, the computer processor may determine a targeted message by associating the set of tags included in the demographic data with the corresponding tags included in each of the stored messages. The stored message that includes the most tags corresponding with the set of tags included in the demographic data may be selected for display. Block 406 may be performed by, for example, the electronic device 106 and/or the external processing server 108.

To illustrate, assume the electronic device 106 generates demographic data indicative of a set of individuals (e.g., 304a-304d, 306). Further, assume the demographic data indicative of the set of individuals (e.g., 304a-304d, 306) indicates that each individual of the set of individuals (e.g., 304a-304d, 306) is an adult female, and that the demographic data include a time of day and a geographic location of the vehicle 102. Thus, adult female, time of day, and the geographic location of the vehicle 102 are the set of tags included in the demographic data. The external processing server 108 may analyze these demographic data to determine a targeted message, and more specifically, a targeted message for adult females at the particular time of day and location. As an example, if the demographic data indicate the set of adult females (e.g., 304a-304d, 306) at a location featuring a plurality of restaurants in the middle of the day, the external processing server 108 may determine a targeted message related to lunch specials at a nearby restaurant.

In embodiments, the computer processor (e.g., external processing server 108) determines the targeted message by correlating the set of distances captured by the proximity sensor with the set of digital images captured by the image sensor. For example, the set of digital images may indicate a set of individuals (e.g., 304a-304d, 306). The set of individuals indicated in the set of digital images may be displaced at various distances from the vehicle 102, as will be correspondingly indicated in the set of distances. The computer processor may determine the targeted message by determining a message that is more relevant to the individuals with a smaller associated distance in the set of distances.

To illustrate, assume there are two individuals closer to the vehicle 102 (e.g., individuals 304a and 304b) than two other individuals (e.g., individuals 304c and 304d), as indicated in the demographic data. The external processing server 108 may analyze the distances in the set of distances to make this determination, and correspondingly weight the remaining data associated with the closer individuals (e.g., 304a, 304b) more heavily than the remaining data associated with the further individuals (e.g., 304c, 304d) when making the targeted message determination. Thus, the external processing server 108 may determine a targeted message that is relevant to some and/or all individuals (e.g., 304a-304d, 306) identified in the demographic data, but that is more relevant to the closer individuals (e.g., 304a, 304b).

In embodiments, determining the targeted message comprises conducting an on-line auction and bidding process. The on-line auction and bidding process may include analyzing one or more of (i) a driving behavior pattern, (ii) a vehicle telemetry indicator, (iii) a current route traveled by the vehicle, (iv) a current roadway traveled by the vehicle, (v) a historical route traveled by the vehicle, (vi) a historical roadway traveled by the vehicle, (vii) a geographic indicator corresponding to the vehicle's position, (viii) a traffic indicator, or (ix) a weather indicator (e.g., collectively referenced herein as “auction impact indicators”). The on-line auction and bidding process may take place in real-time (e.g., as the vehicle 102 drives during a vehicle trip) or prior to the vehicle trip.

For example, the on-line auction and bidding process may involve a number of prospective message providers (e.g., companies, individuals, advertisers). The prospective message providers may participate in the on-line auction, via their respective message provider devices 220, by bidding on durations corresponding to a vehicle (e.g., vehicle 102). The durations may represent periods during which the winning prospective message provider's message will be displayed on the corresponding vehicle 102. The periods may be divided into hours, minutes, seconds, etc. and may include various other indications. In embodiments, the durations may correspond to locations where the vehicle 102 is currently located and/or has previously driven.

To illustrate, assume an on-line auction takes place for displaying messages on a vehicle 102, in accordance with various embodiments herein. The system (e.g., 100, 200) may host prospective message providers on a server (e.g., auction host server 108) through the network 112 via their respective message provider devices 220. The auction host server 108 may provide durations corresponding to periods of time when a prospective message provider's message would be displayed on the vehicle 102. In embodiments, the auction host server 108 may provide one, some, or all of the auction impact indicators to prospective message providers before, during, or after the on-line auction. The auction host server 108 may receive bids from the prospective message providers corresponding to the various durations, and the highest bid will win the duration for displaying that prospective message provider's message.

As an example, assume the on-line auction referenced above takes place for the vehicle 102. The auction host server 108 may display the durations to be auctioned for review by the prospective message providers on their respective message provider devices 220. As mentioned above, the durations may include timestamps indicating the periods of time during a day when the winning bidder's message would be displayed. Moreover, the durations may include geotagged locations (e.g., country, state/province, county/parish, city, town, neighborhood, street address, postal code, etc.) indicating where the vehicle is likely to be at the identified time period. The auction host server 108 may receive the geotagged locations via Global Positioning System (GPS) data and/or any other suitable location data.

The auction may include a duration from 2:30 PM to 3:30 PM, and the duration may indicate, for example, that the vehicle 102 is likely to be in a carpool line at a local elementary school at 3:00 PM on weekdays. The auction may also include a duration from 5:30 PM to 6:30 PM, and the duration may indicate, for example, that the vehicle 102 is likely to be on a busy downtown street at 6:00 PM on weekends. The 2:30-3:30 PM duration may receive more bids from prospective message providers targeting school age children, parents, teachers, etc. Correspondingly, the 5:30-6:30 PM duration may receive more bids from prospective message providers targeting middle aged individuals, business professionals, etc. By contrast, the auction impact indicators may detract from the value of a duration. For example, a duration from 1:00 AM to 2:00 AM in a sparsely populated area may not attract much interest from prospective message providers because the viewership is likely to be minimal.

In embodiments, the auction host server 108 may set the opening bid prices for the durations in an auction based on the auction impact indicators. As discussed herein, the auction impact indicators may affect the number of bids attributable to a duration. Thus, certain auction impact indicators may correspond to known positive impacts on the auction (e.g., would facilitate more bids and/or a higher overall winning bid), and other auction impact indicators may correspond to known negative impacts on the auction (e.g., would facilitate fewer bids and/or a lower overall winning bid). To account for such known impacts, the auction host server 108 may generate an auction profile for a vehicle 102 and/or a driver.

The auction host server 108 may include one, some, or all of the auction impact indicators when generating the auction profile. Moreover, the auction host server 108 may generate an auction profile rating to quickly indicate the attractiveness of displaying messages on a vehicle 102 and/or with a driver. In one example, the auction host server 108 may analyze the driving behaviors of the driver to determine whether the driver generally drives in a cautious or risky manner. If, as an illustration, the driver consistently makes sudden movements with the vehicle 102 (e.g., turns at high speeds, changes lanes quickly, accelerates rapidly from a stop, etc.), generally drives in a risky manner (e.g., drives at night, drives in hazardous weather conditions, does not activate turning signals, drives over the speed limit), and/or otherwise drives in a manner that would produce minimal message display impact (e.g., drives in low population areas) then the auction host server 108 may lower the driver's auction profile rating to suggest that the driver may not be an ideal candidate for a prospective message provider. By contrast, if a driver consistently drives at or under the speed limit and/or makes gentle, controlled movements with the vehicle 102, then the auction host server 108 may raise the driver's auction profile rating to suggest that the driver is an ideal candidate for a prospective message provider.

In embodiments, the auction host server 108 may actively update the generated auction profiles in real-time, and may display reasons why a vehicle 102 and/or driver's profile rating was raised or lowered. For example, if a vehicle's 102 profile rating is lowered 15 points during an auction, the auction host server 108 may display an indication that the vehicle 102 was recently involved in an accident, and thus may be a less desirable candidate for message display. Displaying this information facilitates a more informed bidding decision for the prospective message providers, and may increase the overall functionality of the system (e.g., 100, 200).

As an example, if the auction host server 108 lowers a driver's profile rating based on driving at night, prospective message providers in the automotive lighting industry, handheld lighting industry, and the like may nonetheless be incentivized to bid on late night durations associated with that driver due to the increased likelihood of viewership in conditions relevant to their products/services. Similarly, if the auction host server 108 raises a vehicle's 102 profile rating because the vehicle 102 is a high-value sports car that is likely to attract a higher amount of attention than an average vehicle, prospective message providers in the automotive enhancement industries, sports racing industries, and the like may be incentivized to bid on durations associated with the vehicle 102 due to the increased likelihood of viewership from clientele with interest in their respective markets (e.g., performance car enthusiasts, car racing enthusiasts, etc.).

In embodiments, determining the targeted message comprises transmitting the demographic data to an external processing server (e.g., external processing server 108). Once the external processing server 108 receives the transmitted demographic data, the server 108 may determine the targeted message from the demographic data, and transmit the targeted message to the computer processor.

For example, at optional block 408, the external processing server 108 transmits the targeted message to the electronic device 106. As mentioned herein, in embodiments, the electronic display 104 and the electronic device 106 may be communicatively connected, but physically separate elements. For example, the electronic device 106 may be located in the vehicle 102 interior (e.g., as a connected component of the engine control unit (ECU)), while the electronic display 104 is disposed on the vehicle 102 exterior (e.g., the rear bumper). Thus, additionally or alternatively, the external processing server 108 may transmit the targeted message to the electronic display 104. Optional block 408 may be performed by, for example, the electronic device 106 and/or the external processing server 108.

The method 400 continues at block 410 by displaying the targeted message on the electronic display 104 for viewing by the set of individuals (e.g., 304a-304d, 306) associated with the environment. Thus, the set of individuals (e.g., 304a-304d, 306) may view the targeted message, and may receive the message contained therein. Block 410 may be performed by, for example, the electronic display 104.

As previously discussed in reference to the on-line auction process, and in embodiments, the electronic display 104 displays the targeted message for specified durations. Thus, the electronic display 104 may receive a plurality of targeted messages for display during a plurality of durations. For example, the external processing server 108 may determine that several messages may be relevant to the set of individuals (e.g., 304a-304d, 306) associated with the environment.

In one instance, the external processing server 108 may receive data (e.g., demographic data) indicating that the vehicle 102 is slowly moving (e.g., moving through traffic), and thus may be exposed to a similar set of individuals (e.g., 304a-304d, 306) over a short period of time. In response, the external processing server 108 may conduct an on-line auction to facilitate displaying messages to the set of individuals (e.g., 304a-304d, 306) over a short-term set of durations (e.g., a set of five minute durations over the course of an hour).

Alternatively, the external processing server 108 may receive data (e.g., demographic data) indicating that the vehicle 102 is stationary (e.g., parked in a parking lot), and thus may be exposed to a similar set of individuals (e.g., 304a-304d, 306) over a long period of time. In response, the external processing server 108 may conduct an on-line auction to facilitate displaying messages to the set of individuals (e.g., 304a-304d, 306) over a long-term set of durations (e.g., a set of two hour durations over the course of a day).

In embodiments, and responsive to displaying the targeted message on the electronic display 104, the computer processor (e.g., electronic device 106) may determine one or more of (i) a benefit or (ii) an incentive associated with a policy of the vehicle in exchange for displaying the targeted message. For example, the computer processor may determine that a user has satisfactorily displayed the targeted message (e.g., the targeted message was displayed for the intended duration), and thus qualifies for a benefit associated with their (or their vehicle's 102) insurance policy (e.g., lower premium, lower deductible, elevated coverage level, etc.). Correspondingly, the computer processor may transmit a notification to the external processing server 108 indicating the intended benefit. The external processing server 108 may then access the insurance policy and apply the benefit to the insurance policy. In this way, the system (e.g., 100, 200) facilitates both targeted message display for those within the electronic device's 106 FOV 302, and an improved insurance incentive program whereby users (e.g., customers) have increased satisfaction through lower insurance rates and higher levels of service.

In embodiments, the computer processor (e.g., electronic device 106) may transmit a periodic update for display on a user interface of the vehicle 102 to provide one or more beneficial driving behaviors intended to impact a performance of the vehicle 102 in the on-line auction and bidding process. For example, and as discussed herein with respect to the on-line auction and bidding process, a driver may consistently drive over the speed limit, which may negatively impact their profile rating, as viewed by prospective message providers. Thus, the computer processor may transmit an update to the vehicle's 102 user interface to provide a beneficial driving behavior (e.g., an update suggesting that the user slow down). Additionally, the computer processor may concurrently display the predicted profile rating increase associated with the beneficial driving behavior indicated in the transmitted update. To illustrate, the update may suggest that the driver slow down, and may additionally indicate that should the driver slow down, the associated profile rating will increase by 5 points. Thus, the system (e.g., 100, 200) may facilitate better driving habits, and the vehicle's 102 subsequent performance in the on-line auction and bidding process may be improved, by linking good driving behavior with monetary incentives (e.g., message display revenue, insurance benefits/incentives, etc.). It is to be appreciated that any suitable scoring system or metric may be used for the profile rating.

By providing systems and methods that allow facilitating targeted advertising on automobiles as described herein, various advantages are achieved. For example, the systems and methods provide and/or are implemented through the use of a device(s) that provide information particularly suited for use with other features of the systems and methods to facilitating targeted advertising on automobiles. Notably, the systems and methods provide a seamless, real-time solution to detecting environmental data associated with an environment of a vehicle, generating demographic data from the environmental data, determining a targeted message from the demographic data, and displaying the targeted message. Other advantages will be recognized by one of ordinary skill in the art in light of the teaching and disclosure herein.

As will be apparent from the above description, and as should be appreciated with respect to all examples presented herein, the functions or operations shown in FIG. 4 may be performed in any suitable order, any desired number of times, and/or with any suitable variation to the particular order and/or combination shown so as to achieve a desired result, such as a desired manner of facilitating targeted advertising on automobiles.

### IV. Examples of Additional Considerations

The following additional considerations apply to the foregoing discussion. Throughout this specification, plural instances may implement functions, components, operations, or structures described as a single instance. As noted above, although individual functions and instructions of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The methods described in this application may include one or more functions or routines in the form of non-transitory computer-executable instructions that are stored in a tangible computer-readable storage medium and executed using a processor of a computing device (e.g., the electronic display 104, the electronic device 106, the external processing server 108, the message provider device 220, and/or any other computing devices within the example system (e.g., 100, 200) in any suitable combination). The routines may be included as part of any of the modules described in relation to FIG. 1 and/or FIG. 2 or as part of a module that is external to the system illustrated by FIG. 1 and/or FIG. 2. For example, the methods or portions thereof may be part of a browser application(s) or an application(s) running on any of the devices in the example system (e.g., 100, 200) as a plug-in or other module of the application. Further, the methods may be employed as “software-as-a-service” to provide, for example, the electronic display 104, the electronic device 106, the external processing server 108, the message provider device 220, and/or any other computing devices with access to the example system (e.g., 100, 200).

Additionally, certain aspects are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as an application-specific integrated circuit (ASIC) to perform certain functions). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and/or buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of example functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or functions described herein may be at least partially processor-implemented. For example, at least some of the functions of a method may be performed by one or more processors or processor-implemented hardware modules. The performance of certain of the functions may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic region (e.g., within a home environment, an office environment, or a server farm). In other example embodiments, the one or more processors or processor-implemented modules may be distributed across a number of geographic regions.

Still further, the figures depict preferred embodiments of example systems (e.g., 100, 200) and methods for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for systems and methods for facilitating targeted advertising on automobiles. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the methods and apparatuses disclosed herein without departing from the spirit and scope defined in the appended claims.

To the extent that any meaning or definition of a term in this document conflicts with any meaning or definition of the same term in a document incorporated by reference, the meaning or definition assigned to that term in this document shall govern. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A system for displaying targeted messages on a vehicle, the system comprising:
an electronic display disposed on a surface of the vehicle; and
one or more processors interfacing with the electronic display, the one or more processors configured to:
detect environmental data associated with an environment surrounding the vehicle, the environmental data indicating a set of individuals associated with the environment surrounding the vehicle and a set of distances between the set of individuals and the vehicle;
generate demographic data based at least in part upon the environmental data;
analyze the demographic data to determine a set of tags representative of the set of individuals;
select one or more targeted messages from one or more previously stored messages by matching the set of tags to corresponding tags in the one or more previously stored messages, wherein the one or more targeted messages are selected when the set of tags match the corresponding tags in the one or more previously stored messages by a threshold amount;
prioritize the one or more targeted messages to be displayed by correlating the set of individuals with the set of distances such that a targeted message being viewed by the set of individuals is relevant to one or more individuals in the set of individuals that are closer to the vehicle; and
cause the electronic display to display the targeted message for viewing by the set of individuals.

2. The system of claim 1, further comprising:
an image sensor; and
a proximity sensor;
wherein the environmental data comprise a set of digital images captured by the image sensor and a set of proximity data captured by the proximity sensor, the set of proximity data being indicative of the set of distances between the set of individuals and the vehicle.

3. The system of claim 2, wherein the one or more processors are further configured to prioritize the one or more targeted messages by (i) correlating the set of distances with the set of digital images and (ii) correlating the demographic data with the set of digital images.

4. The system of claim 2, wherein:
the one or more processors are further configured to use one or more of (i) facial recognition, (ii) object recognition, or (iii) object character recognition to generate the demographic data; and
the demographic data include one or more of (i) a location of the vehicle, (ii) a time when the image sensor captured the set of digital images, (iii) an age of a respective individual of the set of individuals, (iv) a gender of the respective individual, (v) a height of the respective individual, or (vi) a weight of the respective individual.

5. The system of claim 1, wherein the one or more processors are further configured to receive the environmental data from one or more of (i) one or more vehicle-to-vehicle communication protocols, (ii) one or more vehicle-to-infrastructure communication protocols, or (iii) one or more mobile devices.

6. The system of claim 1, wherein the one or more processors are configured to determine the one or more targeted messages by conducting an on-line auction and bidding process that analyzes one or more of (i) a driving behavior pattern, (ii) a vehicle telemetry indicator, (iii) a current route traveled by the vehicle, (iv) a current roadway traveled by the vehicle, (v) a historical route traveled by the vehicle, (vi) a historical roadway traveled by the vehicle, (vii) a geographic indicator corresponding to the vehicle's position, (viii) a traffic indicator, or (ix) a weather indicator.

7. The system of claim 6, wherein the one or more processors are further configured to:
responsive to displaying the targeted message, determine one or more of (i) a benefit or (ii) an incentive associated with a policy of the vehicle in exchange for displaying the targeted message; and
transmit a periodic update for display on a user interface of the vehicle to provide one or more beneficial driving behaviors intended to impact a performance of the vehicle in the on-line auction and bidding process.

8. A computer-implemented method for displaying targeted messages on a vehicle, the method comprising:
detecting, by one or more processors, environmental data associated with an environment surrounding the vehicle, the environmental data indicating a set of individuals associated with the environment surrounding the vehicle and a set of distances between the set of individuals and the vehicle;
generating, by one or more processors, demographic data based at least in part upon the environmental data;
analyzing, by one or more processors, the demographic data to determine a set of tags representative of the set of individuals;
selecting, by one or more processors, one or more targeted messages from one or more previously stored messages by matching the set of tags to corresponding tags in the one or more previously stored messages, wherein the one or more targeted messages are selected when the set of tags match the corresponding tags in the one or more previously stored messages by a threshold amount;
prioritizing, by one or more processors, the one or more targeted messages to be displayed by correlating the set of individuals with the set of distances such that a targeted message being viewed by the set of individuals is relevant to one or more individuals in the set of individuals that are closer to the vehicle; and
displaying, by one or more processors, the targeted message on an electronic display disposed on a surface of the vehicle for viewing by the set of individuals.

9. The computer-implemented method of claim 8, further comprising:
receiving, by one or more processors, a set of digital images captured by an image sensor, the environmental data comprising the set of digital images;
receiving, by one or more processors, a set of proximity data captured by a proximity sensor, the environmental data comprising the set of proximity data and the set of proximity data being indicative of the set of distances between the set of individuals and the vehicle; and
prioritizing, by one or more processors, the one or more targeted messages by (i) correlating the set of distances with the set of digital images and (ii) correlating the demographic data with the set of digital images.

10. The computer implemented method of claim 8, wherein determining the one or more targeted messages based at least in part upon the demographic data includes:
transmitting, by one or more processors, the demographic data to an external processing server; and
receiving, by one or more processors, the one or more targeted messages from the external processing server.

11. The computer-implemented method of claim 8, wherein:
generating the demographic data based at least in part upon the environmental data includes using one or more of (i) facial recognition, (ii) object recognition, or (iii) object character recognition; and
the demographic data include one or more of (i) a location of the vehicle, (ii) a time when the image sensor captured the set of digital images, (iii) an age of a respective individual of the set of individuals, (iv) a gender of the respective individual, (v) a height of the respective individual, or (vi) a weight of the respective individual.

12. The computer-implemented method of claim 8, wherein detecting the environmental data associated with the environment surrounding the vehicle includes:
detecting the environmental data from one or more of (i) one or more vehicle-to-vehicle communication protocols, (ii) one or more vehicle-to-infrastructure communication protocols, or (iii) one or more mobile devices.

13. The computer-implemented method of claim 8, wherein determining the one or more targeted messages based at least in part upon the demographic data includes conducting an on-line auction and bidding process that analyzes one or more of (i) a driving behavior pattern, (ii) a vehicle telemetry indicator, (iii) a current route traveled by the vehicle, (iv) a current roadway traveled by the vehicle, (v) a historical route traveled by the vehicle, (vi) a historical roadway traveled by the vehicle, (vii) a geographic indicator corresponding to the vehicle's position, (viii) a traffic indicator, or (ix) a weather indicator.

14. The computer-implemented method of claim 13, further comprising:
responsive to displaying the targeted message, determining, by one or more processors, one or more of (i) a benefit or (ii) an incentive associated with a policy of the vehicle in exchange for displaying the targeted message; and
transmitting, by one or more processors, a periodic update for display on a user interface of the vehicle to provide one or more beneficial driving behaviors intended to impact a performance of the vehicle in the on-line auction and bidding process.

15. A computer readable storage medium comprising non-transitory computer readable instructions stored thereon for displaying targeted messages on a vehicle, the instructions, when executed by one or more processors, cause the one or more processors to:
detect environmental data associated with an environment surrounding the vehicle, the environmental data indicating a set of individuals associated with the environment surrounding the vehicle and a set of distances between the set of individuals and the vehicle;
generate demographic data based at least in part upon the environmental data;
analyze the demographic data to determine a set of tags representative of the set of individuals;
select one or more targeted messages from one or more previously stored messages by matching the set of tags to corresponding tags in the one or more previously stored messages, wherein the one or more targeted messages are selected when the set of tags match the corresponding tags in the one or more previously stored messages by a threshold amount;
prioritize the one or more targeted messages to be displayed by correlating the set of individuals with the set of distances such that a targeted message being viewed by the set of individuals is relevant to one or more individuals in the set of individuals that are closer to the vehicle; and
display the targeted message on an electronic display disposed on a surface of the vehicle for viewing by the set of individuals.

16. The computer readable storage medium of claim 15, wherein the instructions, when executed by the one or more processors, further cause the one or more processors to:
receive a set of digital images, the environmental data comprising the set of digital images; and
receive a set of proximity data, the environmental data comprising the set of proximity data and the set of proximity data being indicative of the set of distances between the set of individuals and the vehicle.

17. The computer readable storage medium of claim 16, wherein the instructions, when executed by the one or more processors, further cause the one or more processors to prioritize the one or more targeted messages by (i) correlating the set of distances with the set of digital images and (ii) correlating the demographic data with the set of digital images.

18. The computer readable storage medium of claim 16, wherein:
the instructions that cause the one or more processors to generate the demographic data based at least in part upon the environmental data further cause the one or more processors to use one or more of (i) facial recognition, (ii) object recognition, or (iii) object character recognition; and
the demographic data include one or more of (i) a location of the vehicle, (ii) a time when the one or more processors captured the set of digital images, (iii) an age of a respective individual of the set of individuals, (iv) a gender of the respective individual, (v) a height of the respective individual, or (vi) a weight of the respective individual.

19. The computer readable storage medium of claim 15, wherein the instructions, when executed by the one or more processors, further cause the one or more processors to receive the environmental data from one or more of (i) one or more vehicle-to-vehicle communication protocols, (ii) one or more vehicle-to-infrastructure communication protocols, or (iii) one or more mobile devices.

20. The computer readable storage medium of claim 15, wherein:
the instructions that cause the one or more processors to determine the one or more targeted messages based at least in part upon the demographic data further cause the one or more processors to conduct an on-line auction and bidding process that analyzes one or more of (i) a driving behavior pattern, (ii) a vehicle telemetry indicator, (iii) a current route traveled by the vehicle, (iv) a current roadway traveled by the vehicle, (v) a historical route traveled by the vehicle, (vi) a historical roadway traveled by the vehicle, (vii) a geographic indicator corresponding to the vehicle's position, (viii) a traffic indicator, or (ix) a weather indicator; and
the instructions, when executed by the one or more processors, further cause the one or more processors to:
responsive to displaying the targeted message, determine one or more of (i) a benefit or (ii) an incentive associated with a policy of the vehicle in exchange for displaying the targeted message; and
transmit a periodic update for display on a user interface of the vehicle to provide one or more beneficial driving behaviors intended to impact a performance of the vehicle in the on-line auction and bidding process.
